(19) United States
(12) Patent Application Publication
(10) Pub. No.: US 2005/0148311 A1
(43) Pub. Date: Jul. 7, 2005

(54) Method and apparatus for improved throughput in a communication system

(76) Inventor: Nicholas William Anderson, Bristol (GB)

Correspondence Address: MORRISON & FOERSTER LLP, 425 MARKET STREET, SAN FRANCISCO, CA, 94105-2482, US

(21) Appl. No.: 10/985,638

(22) Filed: Nov. 10, 2004

(30) Foreign Application Priority Data
Nov. 12, 2003 (GB) 0326405.8

(51) Int. Cl. H04B 1/06

(52) U.S. Cl. 455/277.2; 370/458

(57) ABSTRACT

A scheme for improved throughput in a communication system by combining non-time-coincident macro diversity with timeslot re-use, enabling the benefits of macro diversity to be achieved without substantial impact on the receiver architecture or design. This allows for a significant increase in throughput when transmitting to users close to a cell edge, whilst avoiding any significant increase in UE receiver (900) complexity. It is also extremely beneficial to broadcast services in cellular-like deployments in which large increases in broadcast rate may be achieved whilst maintaining the same broadcast coverage. Preferably, fully non-time-coincident macro-diversity is utilised, but partially-non-time-coincident macro diversity may alternatively be utilised. Preferably, timeslot re-use of order N with macro diversity of order M, where M and N are equal, is utilised, although different values of N and M may alternatively be utilised.

### CROSS-REFERENCE TO RELATED APPLICATIONS

This application claims the benefit of United Kingdom patent application number 0326405.8, filed Nov. 12, 2003, which is incorporated by reference in its entirety herein.

### FIELD OF THE INVENTION

This invention relates to communication systems and particularly (though not exclusively) to Time Division Duplex (TDD) operation in radio communication systems employing timeslot methodology.

### BACKGROUND OF THE INVENTION

In the field of this invention the technique of timeslot re-use is known. The technique of macro diversity is also known and employed in many modern cellular communication systems including IS-95 and the Frequency Division Duplex (FDD) mode of 3GPP WCDMA (3rd Generation Partnership Project Wideband Code Division Multiple Access).

However, such known systems all utilise quasi-continuous transmission and so a requirement to simultaneously receive the multiple (macro-diverse) signals is imposed on the receiver, thereby significantly increasing receiver complexity and ultimately cost.

A need therefore exists for a method and apparatus for improved throughput in a communication system wherein the abovementioned disadvantage(s) may be alleviated.

### STATEMENT OF INVENTION

In accordance with a first aspect of the present invention there is provided a method for improved throughput in a communication system as claimed in claim 1. It will be understood that a transmitter may have multiple antennas, as may a receiver.

In accordance with a second aspect of the present invention there is provided an apparatus as claimed in claim 32.

In accordance with a third aspect of the present invention there is provided a user equipment as claimed in claim 33.

In accordance with a fourth aspect of the present invention there is provided a cellular communication system as claimed in claim 34.

In accordance with a fifth aspect of the present invention there is provided a user equipment as claimed in claim 48.

In accordance with a sixth aspect of the present invention there is provided a method of operation in a cellular communication system as claimed in claim 67.

In accordance with a seventh aspect of the present invention there is provided a method of operation for a user equipment of a cellular communication system as claimed in claim 68.

Some embodiments of the present invention are based on non-time-coincident macro diversity in conjunction with timeslot re-use by which the UE receiver complexity is barely affected over that which would regularly exist for the non-macro-diversity case.

This may allow a significant increase in throughput when transmitting to users close to a cell edge, whilst avoiding any significant increase in UE receiver complexity.

It can also be extremely beneficial to broadcast services in cellular-like deployments in which large increases in broadcast rate may be achieved whilst maintaining the same broadcast coverage.

Although one use is envisaged to utilise fully non-time-coincident macro-diversity, some embodiments of the invention also relate to systems that utilise partially-non-time-coincident macro diversity or fully-time-coincident macro diversity.

Furthermore, a use of the invention is envisaged to employ timeslot re-use of order N with macro diversity of order M, where M and N are equal, although this is not a requirement of the invention.

In a some embodiments of the scheme of the present invention, a digital cellular communications system is assumed to comprise, or have the capability of including, a time-division-multiple access component (TDMA). Timeslot re-use of order N is employed to provide throughput gains for users close to a cell edge (as discussed in the ‘Description of Preferred Embodiment(s)’ section). In this context, if timeslot-segmented macro diversity is employed of order M=N within this re-use scheme, the UE receiver complexity can be left almost entirely unaffected whilst simultaneously benefiting from the throughput gains afforded by macro diversity. Thus, significant throughput gains can be achieved with little/no penalties in terms of receiver complexity—the gains effectively “come for free”.

Normal receiver complexity increase associated with macro diversity can be avoided by separating the multiple constituent radio link transmissions in the time domain. Thus for macro diversity transmission using M radio links, a “single-radio-link” receiver can be run individually on each of M timeslots and the receiver can combine these transmissions to make use of the macro diversity gain. This avoids the need for a “multiple-radio-link” receiver (a receiver which has to simultaneously receive multiple radio links).

Schemes in which M>N and M<N are also possible, although they may not be optimum from a receiver complexity and/or performance perspectives.

The use of a timeslot-segmented macro diversity scheme is suited to cellular deployments and operation in which timeslot re-use is deployed. It is also suited to data transmission to users close to edges of a cell, and furthermore to broadcast systems and services. For users not close to the edges of the cell, reception of a single radio link transmission may be sufficient to provide reliable reception of the transmitted information. Within the scope of the present invention it is possible for a UE to autonomously decide whether or not the reception from a single transmitter or from a subset of the available transmitters is sufficient to provide the desired reception quality and to purposefully not attempt to receive other signals which are known to be of possible use. In such a manner, power consumption of the UE may be reduced and battery life extended.

Broadcast services are presently under consideration within 3GPP under the umbrella of “Multimedia Broadcast and Multicast Services” (MBMS). Such services typically provide point to multi-point communications.

Due to the timeslot-segmented nature of some embodiments of the present invention and its suitability for broadcast services, it is an attractive option for MBMS in 3GPP TDD CDMA, although it should be understood that this does not preclude applicability of the invention to other systems/services.

Within the scope of the present invention, the data sequence transmitted down each radio link constituent of the set of active radio links being used by the UE, may be substantially the same. Here the term “data sequence” is understood to be that following forward error correction—FEC. Thus a repeated copy of the same data sequence or FEC codeword is transmitted on each radio link to convey the enclosed information to the UE. This technique facilitates a technique known as “Chase” combining in the UE in which the multiple copies of the same sequence are weighted according to their SNIR and added before FEC decoding is performed.

However, alternatively or additionally, different redundancy versions (each a sub-set of a longer FEC codeword) may be applied to each radio link, although the information carried by each link is essentially the same. Thus the data sequences transmitted on each radio link are not the same, although the information they carry is. Using such a technique, longer and stronger FEC codewords may be reconstructed at the UE receiver, enhancing the performance of the error correction and reducing the error rate, thus providing an overall link performance improvement or facilitating an increase in data rate for the same error rate or outage.

### BRIEF DESCRIPTION OF THE DRAWINGS

One method and apparatus for improved throughput in a communication system incorporating some embodiments of the present invention will now be described, by way of example only, with reference to the accompanying drawing(s), in which:

FIG. 1 shows a block schematic diagram illustrating a 3GPP radio communication system in which some embodiments of the present invention may be used;

FIG. 2 shows a graphical representation illustrating the cumulative distribution function of the SNIR observed across the deployment area of a typical interference limited cellular system employing re-use of N=1;

FIG. 3 shows a graphical representation illustrating the probability density function of a typical fading radio channel;

FIG. 4 shows a block schematic diagram illustrating a typical tri-sectored cellular deployment employing re-use of N=3;

FIG. 5 shows a graphical representation illustrating a comparison of the cumulative distribution functions of the SNIR observed across the deployment area of a typical cellular system employing re-use of N=1 and N=3;

FIG. 6 shows a graphical representation illustrating downlink SNIR CDF comparison, with/without macro-diversity;

FIG. 7 shows a block schematic diagram illustrating an MBMS (Multimedia Broadcast Multicast Service) architecture;

FIG. 8 shows a block schematic and graphical diagram illustrating an overview of a preferred MBMS transmission scheme incorporating some embodiments of the present invention; and

FIG. 9 shows a block schematic and graphical diagram illustrating relevant components of a UE for using some embodiments the present invention.

### DESCRIPTION OF PREFERRED EMBODIMENTS

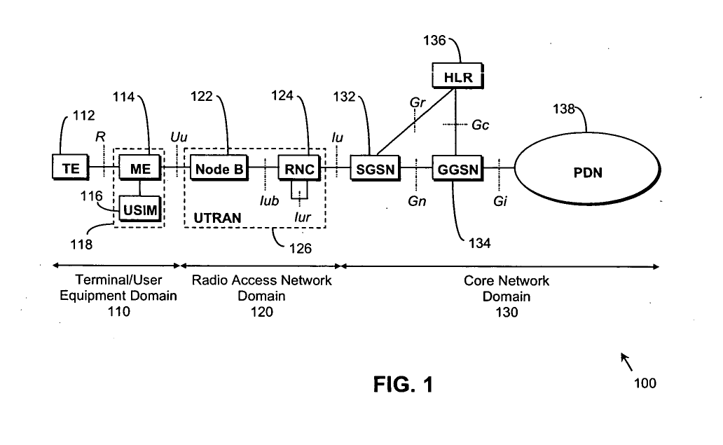

In the following some embodiments of the present invention will be described in the context of a UMTS Radio Access Network (UTRAN) system operating in TDD mode. Referring firstly to FIG. 1, a typical, standard UMTS Radio Access Network (UTRAN) system 100 is conveniently considered as comprising: a terminal/user equipment domain 110; a UMTS Terrestrial Radio Access Network domain 120; and a Core Network domain 130.

In the terminal/user equipment domain 110, terminal equipment (TE) 112 is connected to mobile equipment (ME) 114 via the wired or wireless R interface. The ME 114 is also connected to a user service identity module (USIM) 116; the ME 114 and the USIM 116 together are considered as a user equipment (UE) 118. The UE 118 communicates data with a Node B (base station) 122 in the radio access network domain 120 via the wireless Uu interface. Within the radio access network domain 120, the Node B 122 communicates with a radio network controller (RNC) 124 via the Iub interface. The RNC 124 communicates with other RNC's (not shown) via the Iur interface. The Node B 122 and the RNC 124 together form the UTRAN 126. The RNC 124 communicates with a serving GPRS service node (SGSN) 132 in the core network domain 130 via the Iu interface. Within the core network domain 130, the SGSN 132 communicates with a gateway GPRS support node (GGSN) 134 via the Gn interface; the SGSN 132 and the GGSN 134 communicate with a home location register (HLR) server 136 via the Gr interface and the Gc interface respectively. The GGSN 134 communicates with public data network 138 via the Gi interface.

Thus, the elements RNC 124, SGSN 132 and GGSN 134 are conventionally provided as discrete and separate units (on their own respective software/hardware platforms) divided across the radio access network domain 120 and the core network domain 130, as shown in FIG. 1.

The RNC 124 is the UTRAN element responsible for the control and allocation of resources for numerous Node B's 122; typically 50 to 100 Node B's may be controlled by one RNC. The RNC also provides reliable delivery of user traffic over the air interfaces. RNC's communicate with each other (via the Iur interface) to support handover and macrodiversity.

The SGSN 132 is the UMTS Core Network element responsible for Session Control and interface to the HLR. The SGSN keeps track of the location of an individual UE and performs security functions and access control. The SGSN is a large centralised controller for many RNCs.

The GGSN 134 is the UMTS Core Network element responsible for concentrating and tunnelling user data within the core packet network to the ultimate destination (e.g., internet service provider—ISP).

Such a UTRAN system and its operation are described more fully in the 3GPP technical specification documents 3GPP TS 25.401, 3GPP TS 23.060, and related documents, available from the 3GPP website at www.3Gpp.org, and need not be described in more detail herein.

Available data throughput in digital cellular communication systems is usually linked to signal to noise plus interference (SNIR) conditions at the receiver. For the downlink in such systems throughput is thus a function of the SNIR at the user equipment (UE) or user terminal.

In the definition of SNIR used in the current description, “signal” is understood to be the useful signal power from the cell of interest, “noise” is the thermal noise generated within the receiver itself, and “interference” represents the power of all non-useful signals which cannot be removed by the receiver.

The SNIR at the UE receiver is a function of the mean attenuations (pathloss) of all radio links. Here a radio link is defined as a signal path between a particular transmitter (typically base station) and the user equipment (UE). It should be understood that both the transmitter and/or receiver of the single radio link may employ multiple antennas. In the instantaneous sense the SNIR at the UE receiver is also a function of the fast variations in signal strength of each link (termed “fast fading”). These fast variations in signal strength are in general uncorrelated for each radio link as they depend on the number, amplitude, phase and exact time of arrival of each individual ray comprising each radio link.

Many systems employing redundancy can utilise a frequency re-use of 1 (i.e., all transmitters operate on the same carrier frequency). Without any re-use of, resilience against interference is typically provided and controlled by means of the degree of redundancy added to the data. More redundancy results in higher resilience and increased service coverage. However, increasing redundancy also reduces the information rate. There is thus generally a trade-off between data rate and coverage and the two are usually jointly considered for a particular service deployment. Redundancy can come in many forms. In CDMA systems it is present by virtue of e.g. the spreading code applied to each data symbol. It is also an inherent part of forward error correction (FEC) schemes.

In conjunction with radio link performance curves (SNIR versus error rate) the cumulative distribution of the mean SNIR across locations in a cell can provide an indication of the data rate that can be sustained at the edges of a cell for a given outage. Outage is the measure used to define a percentage area of the cell in which the desired communication link error rate cannot be maintained.

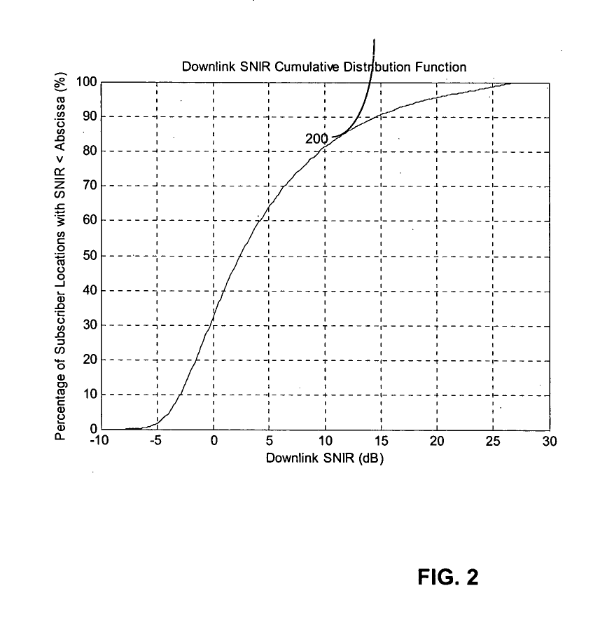

This is demonstrated by means of example below. As shown in FIG. 2, the cumulative distribution function (CDF) 200 of the downlink SNIR is plotted for a typical tri-sectored deployment scenario with a frequency re-use of 1. A link performance curve is considered to be available which reveals that for a given data rate an SNIR of −3 dB is required for a 1% error rate. Looking this up on the CDF 200, it can be seen that a 10% outage will be experienced for this data rate. If the data rate is lowered, the required SNIR for 1% error rate will be correspondingly lowered and so the outage will be reduced. The converse is also true—when the data rate is increased, so is the outage.

It is therefore clear that cell edge throughput at a given outage can be improved via one of the following methods:
(1) Link performance improvement: An improvement (reduction) in the SNIR at which the target error rate is met whilst maintaining the data rate. This allows for an increase in the data rate at a given SNIR whilst maintaining the same error rate, thereby increasing cell edge throughput.

(2) Geographical system SNIR improvement: An improvement in the distribution of the users SNIR for the deployment under consideration. This would result in the CDF curve moving to the right in the plot of FIG. 2, and would allow for higher cell-edge data rates whilst maintaining the same outage.

Known methods of achieving (1) include:
Improved FEC schemes
Improved/advanced modulation techniques
The use of hybrid ARQ when a retransmission is required
Increased channel diversity in fading channels (such as time, space or macro diversity)

Known methods of achieving (2) include:
Improved deployment (antenna patterns/antenna downtilt/antenna positioning/cable losses, etc.)
Frequency re-use schemes
Timeslot re-use schemes
Macro diversity (transmission of the same information to a UE from a plurality of transmitters).

As will be explained in greater detail below, the described embodiments of the present invention provide a technique for data transmission which allows simultaneous improvement of both the link performance and geographical system SNIR distribution with little or no impact on the UE receiver technology.

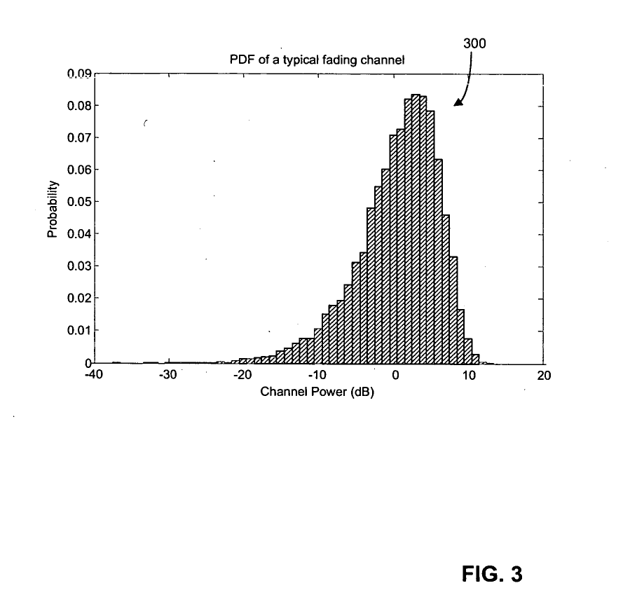

In terms of link performance improvement, the technique exploits an increase in channel diversity in the time domain. For fading channels, there is a certain probability distribution function (PDF) of the instantaneous attenuation of the radio channel. Such a PDF 300 is shown in FIG. 3.

Deep fades result in transmission errors. Time diversity is a technique which exploits the time-varying nature of these fades, and effectively spreads the transmission of one data unit over time in interleaved fashion with redundancy, such that the data is still recoverable without error even in the presence of one or more deep fades. Thus the link performance is improved (it is less sensitive to fading) and the SNIR required for a given error rate is reduced.

In terms of the geographical distribution of SNIR, the technique exploits macro diversity. Macro diversity provides diversity against shadow fading. Each radio link between a transmitter and a UE is subject to a mean attenuation resulting from obstacles (such as buildings) in the propagation path. Some obstacles may be local to the UE (such as the user's house) whilst others may be local to the transmitter. Other obstacles may not be local to either the UE or the transmitter and are simply in the way of the radio signal between them. There is therefore some degree of correlation in the shadow fading observed between multiple radio links to a particular UE (resulting from the obstacle local to the UE), but in general there is a substantial amount of decorrelation and independence in these shadow fading terms. Macro diversity exploits the shadow fading for a given UE location by spreading the transmission of a data unit across a plurality of radio links, such that even if one or more is bad, the data may still be received without error.

In the following description it is firstly proved that a timeslot (or frequency) re-use of factor “N” improves the SNIR CDF by more than “N” times for typical cellular outages. This sets a precedent that timeslot re-use schemes are beneficial in terms of increasing data throughput when transmitting to users located at the edges of the cell.

Secondly, there is described a time-division macro diversity technique that is both complementary to timeslot re-use and to existing UE receiver architectures.

Thirdly, there is described a technique for detecting and decoding these transmissions efficiently in the UE with only minor modifications to the UE receiver architecture.

The Advantage of Timeslot Re-Use

Re-use in cellular systems is a strategic topographical deployment of resources. The resources may be separable in the frequency domain, the time domain, the code domain, or any other separable domain.

For systems employing a Time Division Multiple Access (TDMA) component, timeslot re-use may be employed as opposed to frequency re-use, with similar impact. Especially, for cellular systems for which a single carrier frequency has been designated, timeslot re-use may be employed where frequency re-use is prohibited.

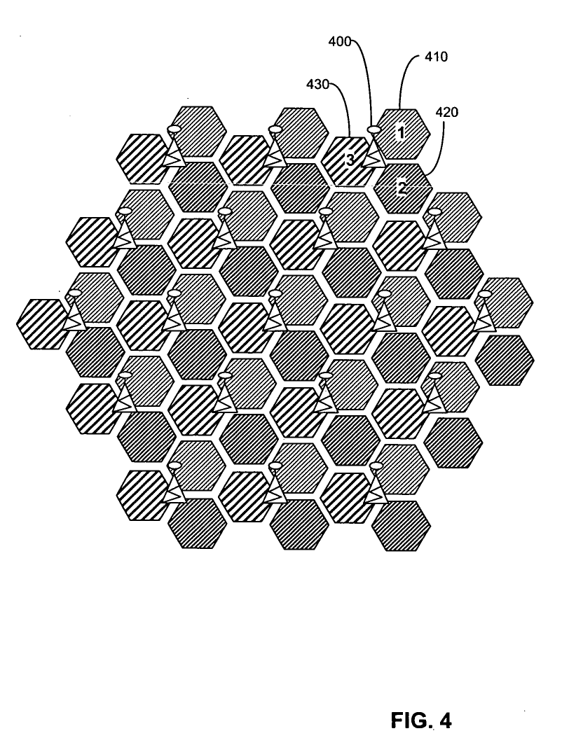

A typical N=3 timeslot re-use scheme is illustrated in FIG. 4. Each cell site (e.g., 410) is tri-sectored and employs 3 transmitters, each transmitting with antenna boresights at 30, 150 and 270 degrees.

Transmission in each sector (e.g., 420, 430 and 440 respectively) is made on only a subset of available timeslots. In this example there are 3 such subsets. The subset to which the transmitter (or sector) belongs is denoted 1, 2 or 3 and is represented by its respective fill-pattern in FIG. 4.

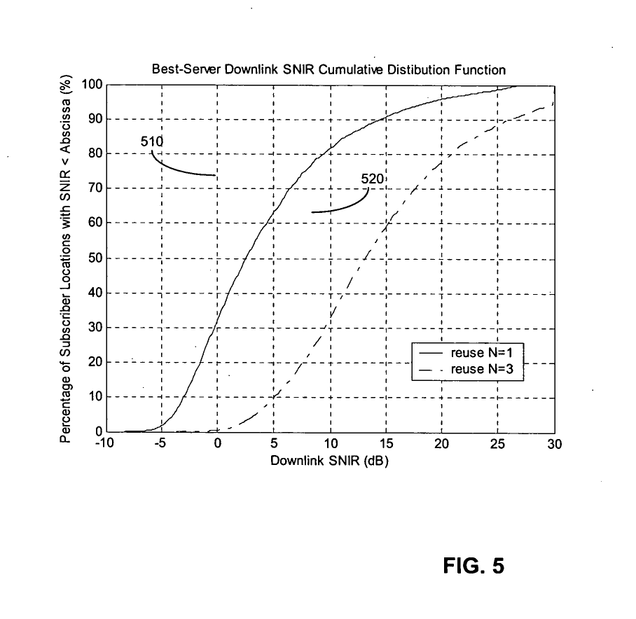

FIG. 5 shows the SNIR CDF's 510 and 520 for the typical tri-sectored deployment of FIG. 4 with timeslot—(or equivalently frequency—) re-use of 1 and 3 respectively.

At a typical outage of (say) 10%, it can be seen that the difference in SNIR is approximately 8 dB (10% corresponds to approximately −3 dB for N=1 and +5 dB for N=3). Assuming the same FEC code-rate, an 8 dB increase in SNIR would correspond to a 6.3 times increase in data rate for the same error rate.

The N=3 re-use consumes 3 times more physical resource (timeslots) than the equivalent N=1 scheme, and so there is one third less throughput per timeslot due to this effect.

However, the 6.3 times increase in throughput resulting from the improvement in geographical distribution of SNIR afforded by the N=3 re-use scheme outweighs this 3-times throughput loss and so the net throughput gain is 6.3/3=2.1 (or a 110% system capacity gain for the same outage). This throughput gain is a function of the desired outage due to the fact that the horizontal distance (dB) between the SNIR CDF curves is not constant with outage (varying in the vertical plane).

By way of example, consider a single-service point-to-point multi-user system without power control which has been designed with sufficient in-built data redundancy to meet a specified outage criterion under N=1 re-use conditions. The fixed per-timeslot information rate “U” to each UE which meets the outage criterion is U_{N=1} bits per second and this consumes a fraction P_{U,(N=)} of the transmitter's transmit power per timeslot. A linear relationship is assumed between the fractional consumed power P_{U} and U: P_{U}∝U.

The number of users that may be simultaneously supported per timeslot is:

$${N}_{U} = \frac{1}{{P}_{U}}$$

If there are N_{TS} timeslots per frame, and N_{cells} cells in the system, then the system wide total throughput for the N=1 re-use case is simply:
system throughputₙ₌₁=U_{N=1}(1/P_{U,(N=1)})N_{TS}N_{cells}

For the N=3 system, there results a multiplicative gain of G_{N=3} in terms of the per-user information rate, whilst maintaining the same outage, as a result of the improved SNIR distribution. Equivalently, since data rate and power are linearly related, this can be viewed as a reduction in the required power P_{U} for the same data rate U_{N=1}:

$${P}_{U , ( N = 3 )} = \frac{{P}_{U , ( N = 1 )}}{{G}_{N = 3}}$$

This has the result that the number of users N_{U} supportable at a data rate U_{N=1} can increase by a factor of G_{N=3} whilst maintaining the same outage. However, the re-use scheme reduces the amount of timeslot resource available per transmitter by a factor of 3 and so:
system throughput_{N=3}=U_{N=1}(1/P_{U,(N=3)})(N_{TS}/3)N_{cells}=U_{N=1}(G_{N=3}/P_{U,(N=1)})(N_{TS}/3)N_{cells}
A net throughput gain results over the N=1 case if G_{N=3} is greater than 3. As shown previously, for 10% outage, G_{N=3}=6.3.
The Advantage of Macro Diversity

Given that timeslot re-use schemes are beneficial in terms of throughput, the following timeslot re-use scheme is considered hereafter. The scheme is an N=3 timeslot re-use in which transmitters are assigned to a transmission “set” 1, 2 or 3 (as labeled in FIG. 4).

Those in transmission set 1 transmit in timeslot TS₁, those in set 2 transmit in timeslot TS₂ and those in set 3 transmit in timeslot TS₃. TS₁, TS₂ and TS₃ are mutually exclusive.

Considering now the case of macro diversity of order M=3 with timeslot re-use N=3, macro diversity of order M requires that each of M transmitters transmits substantially the same information (a data unit) to the UE using a certain amount of power resource from each of the M transmitters.

It should be understood that there is no general requirement for the timeslot/frequency re-use N to be equal to the order of macro diversity M, although M and N are both equal to 3 in the example considered herein.

In this example of macro diversity of order M=3 a special simplified scenario is considered in which the transmission powers are assumed to be equal, represented (as before) as P_{U} per transmitter and per user. These three transmissions arrive at the UE asynchronously and may be combined such that the total collected received SNIR is sufficient to decode the data unit without error. The optimum method for combining the transmissions is to weight each signal according to its received SNIR and to then sum the signals. This method, known as maximum ratio combining (MRC), results in a single signal with SNIR equal to the linear sum of the individual signal SNIR's. Plotting the SNIR CDF for such a 3-way timeslot-segmented macro diversity system in which MRC is used by the receiver, provides an insight into the SNIR distribution gains of this technique, although as mentioned previously, macro diversity also brings about link performance benefits due to the exploitation of channel diversity. These link gains are not revealed by means of the SNIR CDF.

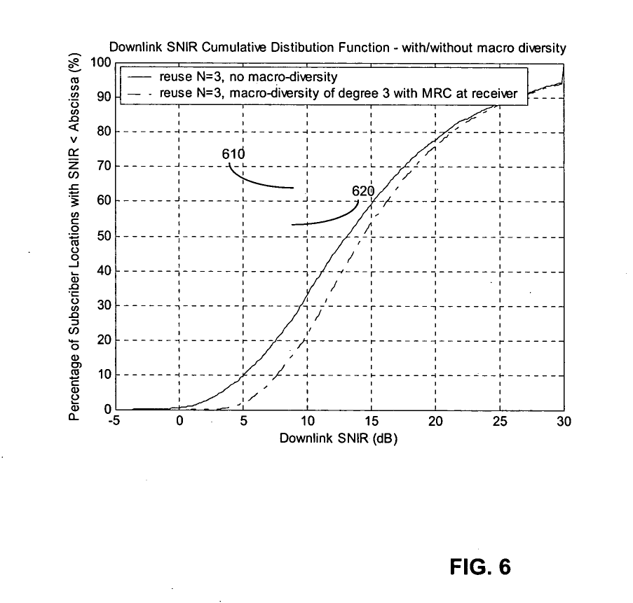

FIG. 6 shows shows the SNIR CDF's 610 and 620 for the typical tri-sectored deployment of FIG. 4 with timeslot—(or equivalently frequency—) re-use of 3 with no macro-diversity and macro-diversity of degree 3 respectively.

It can be seen in FIG. 6 that at 10% outage there is an approximate 2.5 dB gain resulting from the use of macro diversity. This would allow for P_{U} to be reduced by 2.5 dB in each transmitter and this gain in linear terms is denoted as G_{MD} (i.e., in this case G_{MD}=1.78). However, in contrast to the no macro diversity case, each user must be transmitted from each of the 3 transmitters, instead of from only a single transmitter. The total aggregated fractional transmitted power for each user is then increased from P_{U,(N=3)} (for the non-macro-diversity case) to 3*P_{U,(N=3),MD} for the macro-diversity case (the “MD” subscript being used to denote Macro-Diversity). The system throughput equation for N=3 re-use and macro diversity therefore becomes:
system throughput_{N=3,MD}=U_{N=1}(1/3P_{U,(N=3)})(N_{TS}/3)G_{MD}N_{cells}
i.e.,
system throughput_{N=3,MD}=U_{N=1}(G_{N=3}/3P_{U,(N=1)})(N_{TS}/3)G_{MD}N_{cells}
As such, G_{MD} must be greater than 3 in order to achieve a net capacity gain through the use of macro diversity in this simple example.

As was shown previously for this example, G_{MD}=1.78 at 10% outage, and this is clearly not greater than 3. As such, the conclusion could be that macro diversity, if deployed in this ‘blanket’ fashion for all users (irrespective of their location in the cell) is not beneficial for cell throughput. However, in reality, one would only place a subset of users (those experiencing poor C/I—noise/interference) into a macro-diversity-active state. Furthermore, the power transmitted from each contributing transmitter would not be constant as in this example, but in practice would be controlled according to the relative attenuations of each link in order to minimise the total transmitted power.

Furthermore, the example so far has concentrated on a point-to-point multi-user system only. The conclusion has been that for macro diversity of degree “M”, G_{MD} must be greater than M in order to achieve a gain, but this conclusion does not hold for broadcast (point to multipoint) systems. This is because for broadcast systems and services, the same information is transmitted by each transmitter.

For macro diversity in the point-to-point system, each user consumes independent power resources on each of the M transmitters (the total power required for a user is scaled by a factor of M/G_{MD}). For macro diversity in the point-to-multipoint system however, since all transmitters transmit the same data, the total required power is scaled by a factor of 1/G_{MD} only (the factor of M is removed from the equation). Thus, G_{MD} no longer has to be greater than M for a gain to be achieved—it need only be greater than 1.

The conclusion from this is that macro diversity is especially suited to broadcast (as opposed to point-to-point) systems since separate and distinct resources are not required to be replicated on each contributing transmitter for each user.

For the example considered, macro diversity for broadcast systems allows for G_{MD}=1.78 (a 78% throughput gain for the same 10% outage criterion). This gain is the result of SNIR distribution improvement only and further gains will result from improved link performance in fading channels due to the independence of the fast fading on each contributing radio link. These link performance enhancements can be large in deeply fading channels.

Receiver Impacts of Macro Diversity

Macro diversity is currently employed in the art of 3G WCDMA FDD networks. Such transmissions are normally characterised by their continuous nature. When a UE is macro-diversity-active it is said to be in soft handover (SHO). When in SHO, the UE receiver must track and detect the multiple signals arriving and must combine these. This requirement places considerable burden on the UE receiver, which in effect becomes M times more complex, where M is the number of radio links that the receiver must be capable of simultaneously combining.

However, when a macro diversity scheme is deployed in which each transmission is non-time-coincident (the transmissions are not simultaneous), they can be arranged such that they may be received sequentially in time at the receiver, thereby mitigating the need for a receiver capable of simultaneously detecting the plurality of signals and reducing its complexity and cost.

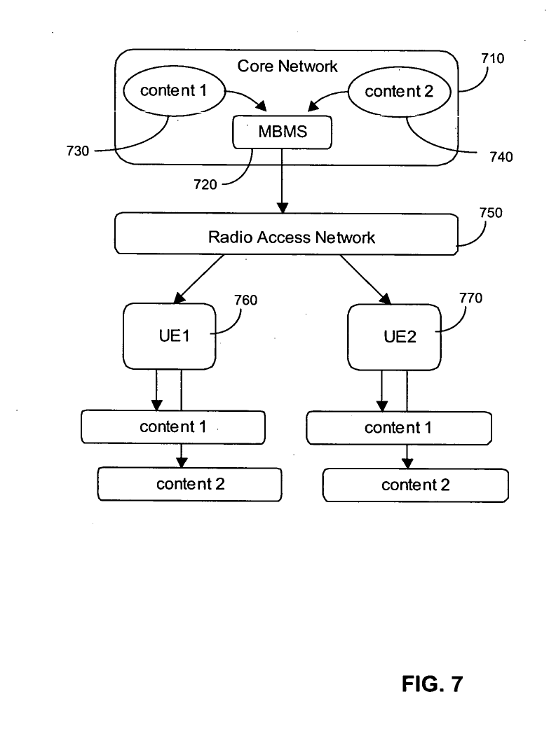

As specified by 3GPP standards, a broadcast service is to be provided within a 3GPP TDD CDMA system. The system should provide point-to-multi-point digital communications. FIG. 7 illustrates a cellular TDD CDMA communication system in according with some embodiments of the invention. Referring now to FIG. 7, a core network portion 710 of a 3GPP TDD CDMA system incorporates a broadcast service (MBMS—Multimedia Broadcast Multicast Service) 720 for broadcasting information from two sources, ‘content 1’ 730 and ‘content 2’ 740, via the radio access network 750 to UEs such as 760 and 770. Here the transmitting “point” is understood to be a higher-layer entity residing in the core network denoted “MBMS”, and the multiple receiving “points” are understood to be UEs such as 760 and 770. It will be understood that the actual physical transmission of the information is not constrained to a point to multi-point implementation and may involve multiple transmission points and also one or more receiving points per UE.

The broadcast service is allocated a certain percentage of the available physical resource of each transmitter. In this example, a total of 3 timeslots are reserved at each transmitter for MBMS service provision.

A frequency re-use of 1 is employed, but a timeslot re-use of 3 is used to improve coverage and data throughput at the edges of the cells. Individual cell sites are tri-sectored and each sector comprises a sector transmitter. Transmitters are assigned to one of 3 MBMS transmission “sets”. Set 1 transmits on timeslot 1, set 2 on timeslot 2 and set 3 on timeslot 3. Each transmitter may only transmit MBMS data on one of the three timeslots allocated for MBMS in accordance with the set to which it is assigned. No MBMS transmission is made by a sector transmitter on either of the other two timeslots which are not assigned to its set. Hence, in the example MBMS data is transmitted by a first transmitter in a first transmit time interval, a second transmitter in a second transmit time interval and a third transmitter in a third transmit time interval. It will be appreciated that in other embodiments different embodiments, a different order of time slot re-use may be employed.

In addition to the MBMS transmissions, a beacon transmission is in the example of FIG. 7 made from each sector transmitter on a predetermined timeslot per radio frame (this timeslot not being a member of the set of MBMS timeslots). In the example, the UE receiver monitors the received signal level or received signal to noise plus interference (SNIR level) of the beacon transmissions in order to select the best received transmitter for normal cellular operation and point-to-point communication.

However, the sector affiliation based upon beacon channel quality may not always be directly relied upon for MBMS sector affiliation because the beacon channel quality may not be representative of the MBMS channel quality. This is due to the use of timeslot re-use on the MBMS channel but not on the beacon. Methods of analysing the beacon receptions may be used to infer the MBMS channel quality but a simpler method is to monitor the MBMS channel quality itself. As such, in this example the UE also monitors the received signal level or received SNIR of the MBMS transmissions in the MBMS-assigned timeslots and uses these measurements to select the sector from each transmission set with the best MBMS signal quality. Thus, for each time slot in which a signal is being transmitted from a plurality of transmitters, the UE may select one transmitter from which to receive the signal. To do this the UE must have some implicit or explicit knowledge of which sector transmitters are members of which transmission sets. Some methods by which this could be achieved are:
A mathematical or predetermined association between transmission set and cell ID/number is established, the cell ID being determined by the UE in normal procedures
Explicit higher-layer signaling is contained in the beacon, MBMS or other channels that identifies to which set that sector and/or other surrounding-sector transmitters belong
Explicit physical layer signaling is employed using physical layer attributes of the beacon, MBMS or other channel transmissions that identifies to which set that sector and/or other surrounding-sector transmitters belong

In this example, the degree of timeslot re-use “N” and the degree of macro diversity “M” are the same (both 3). It should be understood that this is not a requirement of the present invention, it is merely of convenience for this example.

In the generalised case, the UE should select the best serving MBMS sector from each timeslot (regardless of the set to which they belong). In this example however, each set is allocated to a separate timeslot and so selection of the best serving sector in each timeslot is equivalent to selecting the best serving sector from each set.

Having selected the current best serving sector for each timeslot, the UE receiver is configured to receive the MBMS transmission from the best serving sector separately in each timeslot. Thus, the UE receives a first version of the signal in a first receive time interval (a time slot belonging to the first set); a second version of the signal in a second receive time interval (a time slot belonging to the second set) and a third version of the signal in a third receive time interval (a time slot belonging to the third set).

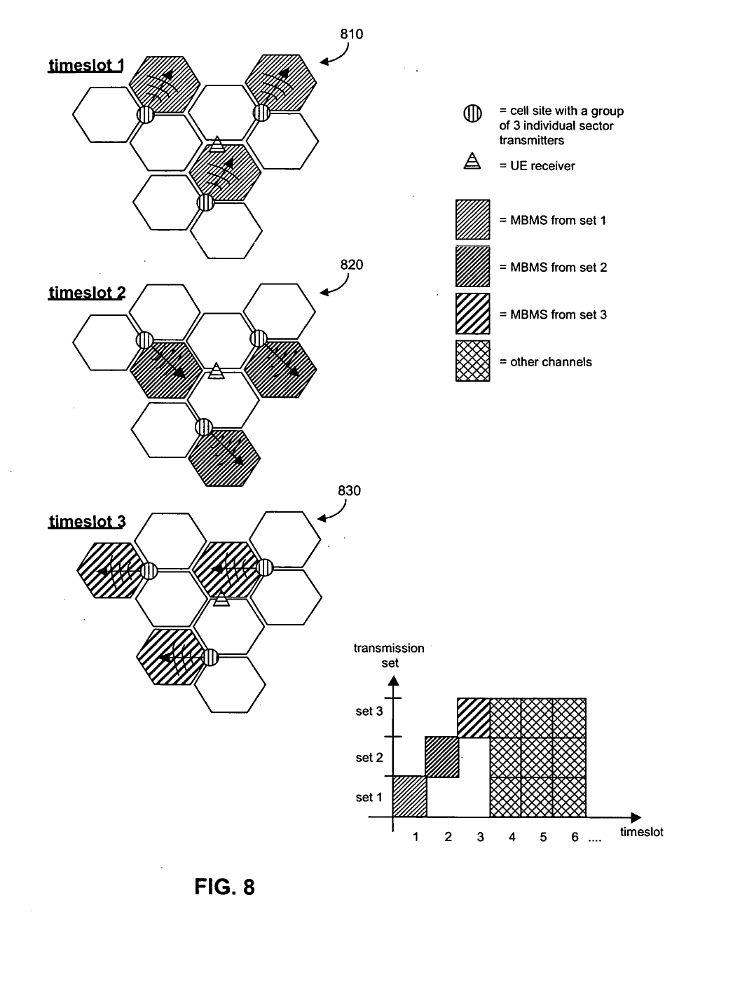

An overview of the MBMS transmission scheme described above is shown in FIG. 8, from which it will be seen that:
at 810, in timeslot 1 MBMS information is broadcast from set 1,
at 820, in timeslot 2 MBMS information is broadcast from set 2, and
at 830, in timeslot 3 MBMS information is broadcast from set 3.

There are therefore 3 individual MBMS receptions per radio frame corresponding to the three timeslots in which they were received. The MBMS data unit being transmitted may also have been spread over multiple radio frames. The length of time over which the transmission of a data unit is spread is termed a “Transmission Time Interval” or TTI. The number of radio frames in the TTI is denoted L_{TTI}. The UE receiver therefore has 3* L_{TTI} timeslot receptions that are related to the data unit.

There are several techniques which may be used by the UE receiver in order to use/combine the information received on these 3* L_{TTI} timeslots before FEC decoding of the data unit is performed.

For the case in which the same data sequence is transmitted from all sets, Chase combining or various forms of selection combining may be performed in the UE. Thus, the different versions of the original MBMS signal received in substantially non-overlapping time intervals (the time slots of the present example) may be combined using Chase combining.

The optimum method of Chase combining is to weight the soft-decision information from each transmission linearly according to the received SNIR, then to sum these versions together wherever they correspond to the same data sequence. This single combined signal (collected over the length of the TTI) is then processed by the FEC decoder in an attempt to recover the underlying information. This technique is known as “maximum ratio combining” or MRC, since it maximizes the received SNIR before decoding.

Various forms of selection combining are also possible. A first method of selection combining may be performed where in each radio frame the receiver selects and stores the soft- or hard-decision information only from the timeslot reception with the best SNIR or quality. This procedure is carried out for each radio frame of the TTI, and the FEC decoder is run on the resultant signal. A second method of selection combining may be performed wherein the soft- or hard-decision information across the full length of the TTI is stored for each transmission set. FEC decoding is then run sequentially on each set until the block is decoded successfully. Only if all of the sets decode unsuccessfully is the data unit received in error.

For the case in which different FEC redundancy versions (different data sequences conveying essentially the same information) are transmitted from each sector transmitter according to their set, the UE receiver may receive all of the transmissions and use them to form one long FEC codeword which is input into the FEC decoder. Here, the combining of the different versions of the underlaying signal from the different sets is effectively achieved within the FEC decoder itself.

It is also possible for a receiver to attempt to jointly detect, or to separately-detect then combine, transmissions from multiple sector transmitters from the same set and hence arriving on the same timeslot. However, this imposes a receiver complexity increase with respect to the non-macro-diversity case. In TDD WCDMA systems, different cell-specific scrambling codes are typically employed by each sector transmitter and this may be exploited within the receiver to distinguish between and/or separate such multiple simultaneously-arriving signals in order to aid in their detection.

In cases in which the UE is in good SNIR conditions (typically away from the edges of the cell), the MBMS receiver may not be activated in all three MBMS timeslots due to the fact that the UE has determined that sufficiently reliable reception may be achieved using the signals received in only one or two MBMS timeslots. UE power consumption is reduced via this technique and battery life is prolonged.

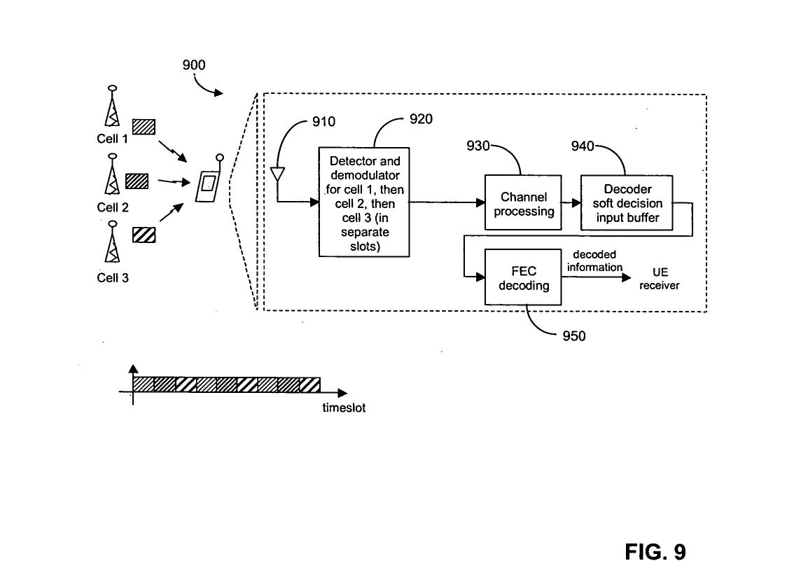

Referring now to FIG. 9, a UE 900 suitable for use in some embodiments of the present invention includes an antenna 910, a detector and demodulator 920 Detector and demodulator for detecting and demodulating time-segmented information received in cell 1, then cell 2, then cell 3 (in separate slots), a channel processing section 930, a decoder soft decision input buffer 940, and a FEC decoding section 950 for providing decoded information to further UE receiver sections (not shown). Thus, the detector and demodulator 920 may demodulate a first version in a first receive time interval (a time slot of time set 1) and subsequently demodulate a second version in a second receive time interval (a time slot of time set 2) and so on.

As explained above, the UE 900 employs a combination of timeslot reuse and non-time-coincident macro-diversity implemented for broadcast services in the network. The UE receiver is capable of receiving and combining multiple radio links. Thus, the UE 900 is able to make use of the inherent macro-diversity without significant increase in receiver complexity. This is because it is capable of activating the single-radio-link receiver in multiple timeslots, each time receiving a signal from different transmitters, and combining these transmissions within either the channel processing unit, the decoder soft decision input buffer or within the FEC decoder itself. Selection combining is considered a subset of combining. The multiple radio link signals do not cross-interfere with each other due to their time orthogonality.

Thus, as described, an MBMS signal may be transmitted using time slot re-use and macrodiversity by a first set of transmitters transmitting a first version of a signal in a first transmit time interval and a second set of transmitters transmitting a second version of a signal in a second transmit time interval. The first and second transmit time intervals are time slots belonging to different sets of the time slot re-use scheme. Furthermore, the time slots are such that the first and second version of the MBMS signal (information) are received in substantially non-overlapping time intervals. Accordingly, the receiver may decode and demodulate the first version in the first time interval and the second version in the second time interval. Furthermore, in each time interval the receiver may select the most appropriate transmitter as previously described. Hence, the best signal of each time slot set may be received by the receiver. The first and second version of the signal, which have been transmitted by different transmitters and which are received in substantially non-overlapping time intervals, may then be combined by the receiver as previously described—for example by maximum likelihood combining or selection combining.

It will be understood that this represents an improvement over timeslot re-use and non-time-coincident macro-diversity implemented for broadcast services in the network where a UE receiver is capable of receiving a single radio link only (such as a UE without joint detection functionality such that the UE is not able to make use of the inherent macro-diversity because it is only capable of receiving signals from a single, best-serving, transmitter).

It will also be understood that use of the UE 900 also represents an improvement over macro-diversity implemented for broadcast services in the network but timeslot re-use not implemented (or partially implemented). The case of timeslot re-use not implemented is traditional macro-diversity in WCDMA FDD, where the UE receiver is capable of simultaneous reception of multiple radio links and UE receiver complexity is increased. There the UE receiver has to be capable of simultaneous reception of multiple radio links using detector/demodulator resources for each. If each of these is effectively a single radio link receiver this known scheme is likely to suffer from inter-radio-link (inter-cell) interference.

It will also be understood that use of the UE 900 also represents an improvement over macro-diversity implemented for broadcast services in the network but timeslot re-use not implemented (or partially implemented), where the UE receiver is capable of simultaneous and joint reception of multiple radio links. In particular, such an arrangement results in a high UE receiver complexity as the UE receiver has to be capable of simultaneous reception of multiple radio links using a single joint detector/demodulator.

It will be understood that the transmitter signals selected by the UE receiver for active reception and/or combination are preferably chosen based upon a quality metric, which may be derived from the received signals themselves, derived from a beacon signal or derived from other signals. The UE receiver may autonomously decide which signals to actively receive and to combine in order to attain the desired reception reliability or quality whilst consuming the minimum electrical power. This may involve switching off the receiver or disabling certain reception circuitry during remaining transmissions of the information unit once the desired estimated or actual quality or reliability has been achieved. Alternatively, the network may instruct or advise the UE which transmitter signals should be received and possibly combined (e.g., the decision within the network being based upon signal measurement reports from the UE, other measurement reports from the UE or on location information).

Also, in the UE receiver parameters enabling improved reception of the signal from each individual transmitter are preferably stored and recalled by the receiver according to which transmitter signal is being received.

Further, it will be understood that in practice in the system, other signals coexist and are also simultaneously transmitted by one or more of the plurality of transmitters, and that these coexisting signals may or may not conform in nature to the transmissions described above in relation to timeslot re-use and timeslot-segmented macro diversity.

It will be appreciated that the method described above for improved throughput may be carried out in software running on processors (not shown) in the transmitter(s) and/or the UE, and that the software may be provided as a computer program element carried on any suitable data carrier (also not shown) such as a magnetic or optical computer disc.

It will be also be appreciated that the method described above for improved throughput may alternatively be carried out in hardware, for example in the form of an integrated circuit (not shown) such as an FPGA (Field Programmable Gate Array) or ASIC (Application Specific Integrated Circuit).

In summary, it will be understood that the method and apparatus for improved throughput in a communication system described above tend to provide the following advantages singularly or in combination:
UE receiver complexity is barely affected over that which would regularly exist for the non-macro-diversity case.
allows for a significant increase in throughput when transmitting to users close to the cell edge, whilst avoiding any significant increase in UE receiver complexity.
extremely beneficial to broadcast services in cellular-like deployments in which large increases in broadcast rate may be achieved whilst maintaining the same broadcast coverage.

It will be appreciated that the above description for clarity has described embodiments of the invention with reference to different functional units and processors. However, it will be apparent that any suitable distribution of functionality between different functional units or processors may be used without detracting from the invention. For example, functionality illustrated to be performed by separate processors or controllers may be performed by the same processor or controllers. Hence, references to specific functional units are only to be seen as references to suitable means for providing the described functionality rather than indicative of a strict logical or physical structure or organization.

The invention can be implemented in any suitable form including hardware, software, firmware or any combination of these. The invention may optionally be implemented at least partly as computer software running on one or more data processors and/or digital signal processors. The elements and components of an embodiment of the invention may be physically, functionally and logically implemented in any suitable way. Indeed the functionality may be implemented in a single unit, in a plurality of units or as part of other functional units. As such, the invention may be implemented in a single unit or may be physically and functionally distributed between different units and processors.

The description and figures have focussed on specific functional blocks of a system incorporating some embodiments of the invention. Some of the individual functional blocks may for example be implemented in a suitable processor such as a microprocessor, a microcontroller or a digital signal processor. The functions of some of the illustrated blocks may for example be implemented as firmware or software routines running on suitable processors or processing platforms. However, some or all of the functional blocks may be implemented fully or partially in hardware. For example, the functional blocks may be fully or partially implemented as analog or digital circuitry or logic.

The functional blocks may furthermore be implemented separately or may be combined in any suitable way. For example, the same processor or processing platform may perform the functionality of more than one of the functional blocks. In particular, a firmware or software program of one processor may implement the functionality of two or more of the illustrated functional blocks. The functionality of appropriate different functional modules may for example be implemented as different sections of a single firmware or software program, as different routines (e.g. subroutines) of a firmware or software program or as different firmware or software programs.

The functionality of the different functional modules may be performed sequentially or may be performed fully or partially in parallel.

Some of the functional elements may be implemented in the same physical or logical element and may for example be implemented in the same network element such as in a base station or a user equipment. In other embodiments, the functionality may be distributed between different functional or logical units.

Although the present invention has been described in connection with some embodiments, it is not intended to be limited to the specific form set forth herein. Rather, the scope of the present invention is limited only by the accompanying claims. Additionally, although a feature may appear to be described in connection with particular embodiments, one skilled in the art would recognize that various features of the described embodiments may be combined in accordance with the invention. In the claims, the term comprising does not exclude the presence of other elements or steps.

Furthermore, although individually listed, a plurality of means, elements or method steps may be implemented by e.g., a single unit or processor. Additionally, although individual features may be included in different claims, these may possibly be advantageously combined, and the inclusion in different claims does not imply that a combination of features is not feasible and/or advantageous. Also the inclusion of a feature in one category of claims does not imply a limitation to this category but rather indicates that the feature is equally applicable to other claim categories as appropriate. Furthermore, the order of features in the claims do not imply any specific order in which the features must be worked and in particular the order of individual steps in a method claim does not imply that the steps must be performed in this order. Rather, the steps may be performed in any suitable order. In addition, singular references do not exclude a plurality. Thus references to “a”, “an”, “first”, “second” etc do not preclude a plurality.

1. A method for improved throughput in a communication system including a plurality of transmitters and at least one receiver, the method comprising:
transmitting information from the plurality of transmitters
utilising a timeslot re-use scheme in which a timeslot used for transmission varies between the plurality of transmitters and
utilising a timeslot-segmented macro diversity scheme in which copies of the same information are transmitted from the plurality of transmitters; and
receiving at the receiver the transmissions from the plurality of transmitters and retrieving the information by at least one of A-B:
A selection among the plurality of received transmissions, and
B combination among the plurality of received transmissions.

2. The method of claim 1 wherein the timeslot re-use scheme comprises varying the timeslot used for transmission based on one of C-D:
C a predetermined re-use pattern, and
D a dynamically-varying re-use pattern.

3. The method of claim 1 wherein the timeslot-segmented macro diversity scheme comprises transmitting the same information from the plurality of transmitters during one of E-F:
E substantially coincident time periods, and
F substantially mutually exclusive time periods.

4. The method of claim 1 in which the plurality of transmissions comprise data sequences that after FEC encoding are substantially the same.

5. The method of claim 1 wherein the plurality of transmissions comprise data sequences that after FEC encoding are substantially different and which are each a subset of a longer FEC codeword.

6. The method of claim 1 wherein reception of the plurality of transmissions is performed time-serially by a same detector.

7. The method of claims 1 wherein the system comprises a 3GPP TDD WCDMA system.

8. The method of claim 1 wherein the method comprises broadcast or point-to-multipoint services.

9. The method of claim 8 wherein the services comprise 3GPP Multimedia Broadcast and Multicast Services (MBMS).

10. The method of claim 1 wherein the plurality of transmissions comprise data sequences which are combined at the receiver in order to improve the received quality or reliability of the transmission.

11. The method of claim 10 in which the data sequences are selected or combined according to a quality metric derived by the receiver.

12. The method of claim 11 in which different data sequences are used to reform a longer codeword which is input into an FEC decoder.

13. The method of claim 1 wherein a supplementary signal is transmitted from a transmitter to the receiver indicating to which transmission set the transmitter belongs.

14. The method of claim 13 wherein the supplementary signal also conveys set affiliation information for other transmitters.

15. The method of claim 14 wherein the supplementary signal is conveyed on a beacon or cell broadcast channel.

16. The method of claim 13 wherein the supplementary signal is conveyed on a broadcast or MBMS channel.

17. The method of claim 1 wherein an implicit mapping between a transmitter identity and it's transmission set is used to convey information from a transmitter to the receiver indicating to which transmission set the transmitter belongs.

18. The method of claim 1 wherein characteristics of a physical-layer signal are used to convey information from a transmitter to the receiver indicating to which transmission set the transmitter belongs.

19. The method of claim 18 wherein the physical layer characteristic is of a beacon or cell broadcast physical channel.

20. The method of claim 18 wherein the physical layer characteristic is of the physical channel used to convey a broadcast or MBMS service.

21. The method of claim 18 wherein the physical layer characteristic is of a dedicated, shared or common physical channel.

22. The method of claim 1 wherein transmitter signals selected by the receiver for active reception are chosen based upon a quality metric.

23. The method of claim 22 in which the quality metric is derived from the received signals themselves.

24. The method of claim 22 in which the quality metric is derived from a beacon signal.

25. The method of claim 22 wherein the quality metric is derived from a signal other than the received signals themselves or a beacon signal.

26. The method of claim 1 wherein parameters enabling improved reception of the signal from each of the plurality of transmitters are stored and recalled by the receiver according to which transmitter signal is being received.

27. The method of claim 1 wherein the receiver autonomously decides which signals to actively receive and from which to retrieve information in order to attain a desired reception quality.

28. The method of claim 27 wherein the receiver disables certain reception circuitry during remaining transmissions of the information once the desired quality has been achieved.

29. The method of claim 1 wherein the system advises the receiver which transmitter signals should be received.

30. The method of claim 29 wherein the system's advice is based upon at least one of G-H:
G signal measurement reports from the receiver,
H other measurement reports from the receiver,
I location information.

31. A computer program element comprising computer program means for performing the method of claim 1.

32. An apparatus for improving throughput in a communication system including a plurality of transmitters and at least one receiver, the apparatus comprising:
the plurality of transmitters being operable to transmit information
utilising a timeslot re-use scheme in which a timeslot used for transmission varies between the plurality of transmitters and
utilising a timeslot-segmented macro diversity scheme in which copies of the same information are transmitted from the plurality of transmitters; and
the at least one receiver being operable to receive the transmissions from the plurality of transmitters and to retrieve the information by at least one of A-B:
A selection among the plurality of received transmissions, and
B combination among the plurality of received transmissions.

33. A user equipment comprising a receiver being operable to
receive transmissions from a plurality of transmitters transmitting information
utilising a timeslot re-use scheme in which a timeslot used for transmission varies between the plurality of transmitters and
utilising a timeslot-segmented macro diversity scheme in which copies of the same information are transmitted from the plurality of transmitters; and
retrieve the information by at least one of A-B:
A selection among the plurality of received transmissions, and
B combination among the plurality of received transmissions.

34. A cellular communication system comprising:
a first number of transmitters arranged to transmit a first version of a signal in a first transmit time interval;
a second number of transmitters arranged to transmit a second version of the signal in a second transmit time interval;
wherein the first and second time intervals are such that the first and second version are received in substantially non-overlapping time intervals at a user equipment.

35. The cellular communication system claimed in claim 34 wherein the first transmit time interval is a first time slot of a TDMA frame and the second transmit time interval is a second time slot of the TDMA frame.

36. The cellular communication system claimed in claim 34 wherein the first and second plurality of transmitters are associated with different time slot sets of a time slot re-use scheme.

37. The cellular communication system claimed in claim 34 further comprising means for transmitting a supplementary signal indicative of a first time slot set associated with the first number of transmitters and a second time slot set associated with the second number of transmitters.

38. The cellular communication system claimed in claim 37 wherein the means for transmitting the supplementary signal is operable to transmit the supplementary signal on a beacon or cell broadcast channel.

39. The cellular communication system claimed in claim 37 wherein the means for transmitting the supplementary signal is operable to transmit the supplementary signal on a broadcast or MBMS channel.

40. The cellular communication system claimed in claim 34 wherein the signal is a broadcast or point-to-multipoint signal.

41. The cellular communication system claimed in claim 34 further comprising means for generating the first version by applying a first error encoding scheme to a data sequence; and
means for generating the second version by applying a second error encoding scheme to the data sequence.

42. The cellular communication system claimed in claim 34 further comprising:
means for generating a FEC encoded data block from an information data block;
means for generating the first version by selecting a first subset of data from the FEC encoded block; and
means for generating the second version by selecting a second subset of data from the FEC encoded block.

43. The cellular communication system claimed in claim 34 further comprising a user equipment for a cellular communication system comprising:
means for selecting a first transmitter of the first number of transmitters;
means for receiving the first version in a first receive time interval from the first transmitter;
means for selecting a second transmitter of the second number of transmitters;
means for receiving the second version in a second receive time interval from the second transmitter, the second receive time interval being substantially non-overlapping with the first receive time interval; and
means for generating the signal by combining the first and second received version.

44. The cellular communication system claimed in claim 34 wherein the first number of transmitters comprise a plurality of transmitters.

45. The cellular communication system claimed in claim 34 wherein the second number of transmitters comprise a plurality of transmitters.

46. The cellular communication system claimed in claim 34 wherein the cellular communication system comprises a 3GPP TDD WCDMA system.

47. The cellular communication system claimed in claim 34 wherein the signal comprise a 3GPP Multimedia Broadcast and Multicast Services (MBMS) signal.

48. A user equipment for a cellular communication system comprising:
means for selecting a first transmitter of a first number of transmitters transmitting a first version of a signal;
means for receiving the first version in a first time interval from the first transmitter;
means for selecting a second transmitter of a second number of transmitters transmitting a second version of a signal;
means for receiving the second version in a second time interval from the second transmitter, the second time interval being substantially non-overlapping with the first time interval; and
means for generating the signal by combining the first and second received version.

49. The user equipment claimed in claim 48 wherein the means for generating the signal is operable to combine the first and second received version by selection combining.

50. The user equipment claimed in claim 48 wherein the means for generating the signal is operable to combine the first and second received version by maximum likelihood combining.

51. The user equipment claimed in claim 48 wherein the first and second version comprise data sequences that after FEC encoding are substantially different and which are each a subset of a longer FEC codeword; and the means for combining is operable to determine the FEC codeword in response to the first and second version.

52. The user equipment claimed in claim 48 wherein the first time interval is a first time slot of a TDMA frame and the second time interval is a second time slot of the TDMA frame.

53. The user equipment claimed in claim 48 wherein the signal is a broadcast or point-to-multipoint signal.

54. The user equipment claimed in claim 48 wherein a same receiver of the subscriber unit is arranged to receive the first and second version time-serially.

55. The user equipment claimed in claim 48 further comprising means for receiving a supplementary signal indicative of a first time slot set associated with the first number of transmitters and a second time slot set associated with the second number of transmitters.

56. The user equipment claimed in claim 55 wherein the means for receiving the supplementary signal is operable to receive the supplementary signal on a beacon or cell broadcast channel.

57. The user equipment claimed in claim 56 wherein the means for receiving the supplementary signal is operable to receive the supplementary signal on a broadcast or MBMS channel.

58. The user equipment claimed in claim 48 wherein the means for selecting the first transmitter is operable to select the first transmitter in response to a quality metric.

59. The user equipment claimed in claim 58 further comprising means for deriving the quality metric from a receive characteristic of the first version.

60. The user equipment claimed in claim 58 further comprising means for deriving the quality metric from a receive characteristic of a beacon signal.

61. The user equipment claimed in claim 48 further comprising means for retrieving stored receive parameters for the first transmitter.

62. The user equipment claimed in claim 48 further comprising means for disabling certain reception circuitry during remaining transmissions of the signal once a desired quality has been achieved.

63. The user equipment claimed in claim 48 wherein the first number of transmitters comprise a plurality of transmitters.

64. The user equipment claimed in claim 48 wherein the second number of transmitters comprise a plurality of transmitters.

65. The user equipment claimed in claim 48 wherein the cellular communication system comprises a 3GPP TDD WCDMA system.

66. The user equipment claimed in claim 48 wherein wherein the signal comprise a 3GPP Multimedia Broadcast and Multicast Services (MBMS) signal.

67. A method of operation in a cellular communication system including a first number of transmitters and a second number of transmitters; the method comprising:
the first number of transmitters transmitting a first version of a signal in a first transmit time interval;
the second number of transmitters transmitting a second version of the signal in a second transmit time interval;
wherein the first and second time intervals are such that the first and second version are received in substantially non-overlapping time intervals at a user equipment.

68. A method of operation for a user equipment of a cellular communication system comprising:
selecting a first transmitter of a first number of transmitters transmitting a first version of a signal;
receiving the first version in a first time interval from the first transmitter;
selecting a second transmitter of a second number of transmitters transmitting a second version of a signal;
receiving the second version in a second time interval from the second transmitter, the second time interval being substantially non-overlapping with the first time interval; and
generating the signal by combining the first and second received version.
